(19) United States
(12) Patent Application Publication
(10) Pub. No.: US 2024/0406929 A1
(43) Pub. Date: Dec. 5, 2024

(54) EFFICIENT IDENTIFICATION AND DOWNLOAD OF OFFLINE MAPS

(71) Applicant: Apple Inc., Cupertino, CA (US)

(72) Inventors: Frank S. Fejes, III, Los Altos, CA (US); Scott G. Jackson, San Francisco, CA (US); Michael H. Schrag, Doswell, VA (US); Ozgur Ekici, Ottawa (CA); Venkata S. Kondapalli, San Jose, CA (US); Rachid Kachemir, Mountain View, CA (US)

(73) Assignee: Apple Inc., Cupertino, CA (US)

(21) Appl. No.: 18/674,259

(22) Filed: May 24, 2024

Related U.S. Application Data
(60) Provisional application No. 63/470,794, filed on Jun. 2, 2023.

(51) Int. Cl. H04W 64/00

(52) U.S. Cl. CPC H04W 64/006

(57) ABSTRACT

A method may include accessing service data associated with a service and associated with a group of geographical regions. The method may also include assigning at least some of the service data of the group of geographical regions corresponding to a map tile. The method may include generating an initial batch of service data corresponding to the map tile, thereby generating initial batches of service data. The method may also include receiving, from a mobile device, a request to download map data corresponding a geographical area. The method may also include determining one or more map tiles corresponding to the geographical area. The method may also include determining a subset of the initial batches associated with the one or more map tiles corresponding to the geographical area. The method may also include providing, to the mobile device, the subset of the initial batches responsive to the request.

### CROSS-REFERENCES TO OTHER APPLICATIONS

This application claims priority to U.S. Provisional Application No. 63/470,794, for “EFFICIENT IDENTIFICATION AND DOWNLOAD OF OFFLINE MAPS” filed on Jun. 2, 2023, which is herein incorporated by reference in its entirety for all purposes.

### BACKGROUND

One or more services may rely on map data to function properly. Service data related to the one or more services may not be available in areas where there is no wireless network coverage. As the service data may include large amounts of data, there is a need to provide for efficient delivery and storage of service data for maps, as well as a determination of which data should be downloaded.

### BRIEF SUMMARY

In one embodiment, a method may include receiving location data associated with a destination location of a mobile device. The method may also include determining a geographical area associated with the destination location, the geographical area defined around the destination location. The method may also include determining an expected wireless network coverage level for each of a set of map tiles corresponding to the geographical area. The method may then include generating a total expected wireless network coverage level of the geographical area by combining the expected wireless network coverage of each map tile. In response to determining that the total expected wireless network coverage level is below a threshold, the method may also include providing, to the mobile device, map data or a prompt to download the map data associated with the geographical area.

In some embodiments, determining the expected wireless network coverage level further may include determining carrier information associated with the mobile device. The method may also include determining that the destination corresponds to a country other than a country associated with the mobile device. The method may then include providing, to the mobile device, the prompt to download the map data associated with the geographical area.

In some embodiments, determining the expected wireless network coverage level further may include determining a first network provider associated with the mobile device and accessing one or more historical network coverage data points of the first network provider for each of the set of map tiles corresponding to the geographical area.

In some embodiments, determining the expected wireless network coverage level further may include determining a first network provider associated with the mobile device. The method may then include accessing one or more historical network coverage data points of a second network provider for each of the set of map tiles corresponding to the geographical area. The method may then include inferring the expected wireless network coverage level based at least in part on the historical network coverage data points of the second network provider.

In some embodiments, the map data may include service data associated with one or more services. In some embodiments, the geographical area associated with the destination location may be determined based at least in part on the destination.

In an embodiment, a computing system may include one or more processors. The system may include one or more computer-readable memories may include instructions that, when executed by the one or more processors, cause the computing system to perform operations. In performing the operations, the computing system may receive location data associated with a destination location of a mobile device. The computing system may then determine a geographical area associated with the destination location, the geographical area defined around the destination location. The computing system may determine an expected wireless network coverage level for each of a set of map tiles corresponding to the geographical area. The computing system may combine the expected wireless network coverage level of each of the set of map tiles to generate a total expected wireless network coverage level of the geographical area. In response to determining that the total expected wireless network coverage level is below a threshold, the computing system may provide, to the mobile device, map data or a prompt to download the map data associated with the geographical area.

In an embodiment, a computer-readable medium may store a plurality of instructions. When executed by one or more processors of a computing device, the one or more processors may perform operations. The operations may include receiving location data associated with a destination location of a mobile device. The operations may also include determining a geographical area associated with the destination location, the geographical area defined around the destination location. The operations may also include determining an expected wireless network coverage level for each of a set of map tiles corresponding to the geographical area. The operations may then include generating a total expected wireless network coverage level of the geographical area by combining the expected wireless network coverage of each map tile. In response to determining that the total expected wireless network coverage level is below a threshold, the operations may also include providing, to the mobile device, map data or a prompt to download the map data associated with the geographical area.

In an embodiment, a method may include accessing service data associated with a service and associated with a group of geographical regions. For each of a set of map tiles, the method may also include assigning at least some of the service data of the group of geographical regions corresponding to the map tile. The method may include generating an initial batch of service data corresponding to the map tile, thereby generating initial batches of service data. The method may also include receiving, from a mobile device, a request to download map data corresponding a geographical area. The method may also include determining one or more map tiles corresponding to the geographical area. The method may also include determining a subset of the initial batches associated with the one or more map tiles corresponding to the geographical area. The method may also include providing, to the mobile device, the subset of the initial batches responsive to the request.

In some embodiments, the method may also include determining that two or more of the initial batches may include a set of shared data. The method may then include generating a synthetic batch including the set of shared data associated with the two or more of the initial batches. The method may then include removing the set of shared data from the two or more of the initial batches and determining that the synthetic batch corresponds to the geographical area of the request. The method may also include providing the synthetic batch to the mobile device responsive to the request. The set of shared data may include data associated with a particular zoom level. The set of shared data may include data shared between two or more adjacent map tiles of a same zoom level. The synthetic batch may include metadata that associates the set of shared data with each of the two or more initial batches. The geographical area may be determined by a user input. The geographical area may be automatically determined according to a destination location. The service data may be organized according to the set of map tiles prior to assigning the at least some of the service data to the set of map tiles.

### BRIEF DESCRIPTION OF THE DRAWINGS

FIG. 1 illustrates a block diagram of a user device downloading offline map data, according to at least one embodiment.

FIG. 2 illustrates a mobile device determining a destination, according to at least one embodiment.

FIG. 3 illustrates a server identifying a geographical area associated with a destination, according to at least one embodiment.

FIG. 4 illustrates an expected wireless network coverage of a geographical area, according to at least one embodiment.

FIG. 5 illustrates a flowchart of a method for providing a download recommendation, according to at least one embodiment.

FIG. 6 illustrates a server accessing service data and a map, according to at least one embodiment.

FIG. 7 illustrates data organized into initial batches, according to at least one embodiment.

FIG. 8 illustrates synthetic batches including duplicate data removed from initial batches, according to at least one embodiment.

FIG. 9 illustrates a simplified diagram of a server providing requested batches to a mobile device, according to at least one embodiment.

FIG. 10 illustrates a flowchart of a method for batching data for offline download, according to at least one embodiment.

FIG. 11 illustrates a block diagram of an example electronic device, according to at least one embodiment.

### DETAILED DESCRIPTION

Generally, services on mobile devices access data as needed from a remote server via a network connection. Cellular phones, for example, may connect to the server using cell towers associated with a network provider. Many of these services are relied upon by users for navigation, general information about an area, and other basic uses. Due to the mobile nature of these devices, the user may access data about a wide variety of geographic locations from a wide variety of geographic locations. At least some of these locations may not be able to connect with the server due to poor network coverage at the geographic location. Therefore, the data required by the services must be available to the mobile device when the mobile device is in an area with poor coverage.

Each service may require large amounts of data, so downloading all the data a service may need for all locations may be prohibitively expensive, both in the delivery and storage of the data. Only the data relevant to a location the mobile device may be at in the future, where the location has poor coverage may be necessary for download. Thus, it may be beneficial to determine the location and relevant data thereof before the mobile device is at the location (e.g., while the mobile device may still access the server). Once the location and data have been determined, efficient delivery of the data may also be beneficial.

To determine the location, the mobile device may utilize data from the mobile device corresponding to the location. For example, a user may plan a route to the location. The mobile device may then identify the location for further analysis. In another example, the user may make a hotel reservation, book a flight, or perform some other action that generates predictive data suggesting the user (and therefore the mobile device, may be at the location in the future). After determining the location, a server may determine an expected network coverage of an area including and surrounding the area. If the server determines that the mobile device should expect to not have access due to poor network coverage, the server may cause the mobile device to prompt a download of data associated with the area.

In order to efficiently download the right amount of data, relevant to the location, data may be batched into non-overlapping batches. The server may access service data associated with one or more services that run on a mobile device. Regardless of how the service data is organized, the server may assign the service data to one or more relevant map tiles of a map representing a geographic region. The server may thereby create initial batches of data associated with each of the map tiles. The server may then eliminate duplicate data from the initial batches, creating synthetic batches. The server may then receive a request for service data for a geographical area from the mobile device. In response to the request, the server may provide the corresponding initial batches and synthetic batches to the mobile device.

### I. Offline Maps

Maps and other information associated with a geographic region are commonly accessed by users via mobile devices. The maps and other information may relate to one or more services in connection with a particular destination a user is visiting. If there is cellular data accessible by the mobile device, the maps and other information may be accessed at will. This is not always the case, however.

In some areas, cellular coverage may be non-existent or unreliable. A user may still wish to access the maps and other information at a destination where cellular coverage is lacking, however. To accomplish this, the maps and other information may be downloaded from a server to the mobile device prior to the user arriving at the destination. This may present several obstacles, however.

One obstacle may be identifying when the maps and other information should be downloaded prior to the arrival at the destination. In order to identify what maps and other information should be downloaded, the destination may need be identified and the cellular coverage at the destination determined. Identifying the destination may require identifying not only a specific location of the destination, but also a surrounding area around the destination where a user may be likely to go. Determining the cellular coverage at the destination and surrounding area prior to the user arriving may require prior knowledge of the general state of cellular coverage there.

Another obstacle relates to the quantity of data needed to provide the maps and other information in a useful and efficient way. Too much data may make downloading the maps and other information inefficient both in delivery and storage of the data. Too little data and the maps and other information may not be useful. Furthermore, the maps and other information may include duplicate data. The duplicate data may lead to inefficiencies in delivery and storage of the data.

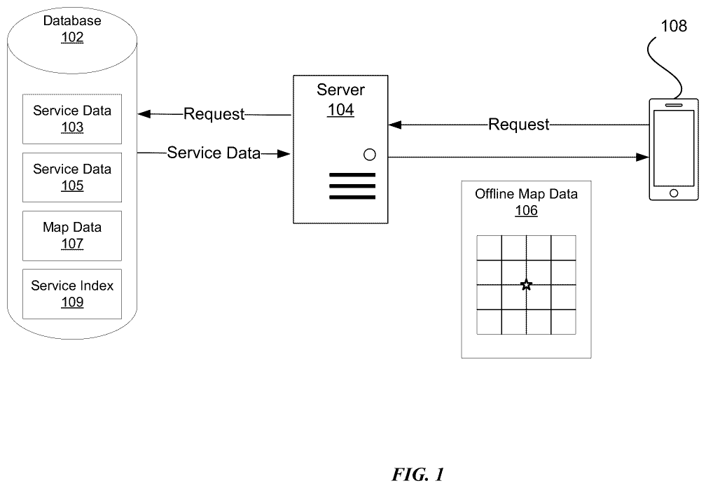

FIG. 1 illustrates a block diagram of a mobile device 108 downloading offline map data, according to at least one embodiment. The block diagram 100 may include a database 102, a server 104, offline map data 106, and the mobile device 108. The database 102 may contain service data 103 and 105 and map data 107. Although only one database 102 is shown, there may be any number of databases. For example, the database 102 may contain the map data 107 and a second database may contain the service data 103 and 105. There may also be additional databases holding additional service data.

The service data 103 and 105 may be downloaded to the mobile device 108 and allow one or more services to operate while the mobile device 108 is not connected to a wireless network. Example services may include routing services, search services, and other such services. For example, the service data 103 may be associated with the search service. The service data 103 may therefore include offline information generally available through a web search or other search performed while connected to a network. Using the service data 103 while offline, a user may search for “restaurants near me” and the service data associated with the search service may return a list of restaurants within a certain proximity to the mobile device 108. The list may include other information such as hours, location, menu, and other suitable information.

The service data 105 may include historical traffic data, construction data, or other travel-related data to plan a route from one destination to another. The service data 105 information is sourced from either from other devices or official sources. For example, municipalities can provide location information when they perform re-routing of roads due to construction. The routing service may then use the service data 105 to perform routing functions while the mobile device 108 is offline. In both cases, the service data 103 and 105 data may include a reference to one or more geographical regions. While the service data 103 and 105 may reference the same or similar geographical regions, portions of the service data 103 and 105 may reference different geographical regions and/or overlapping geographical regions (e.g., map tiles of differing zoom levels).

### A. Assigning of Service Data to Map Tiles

To make the service data 103 and 105 available for download (and thus enable services to function offline), the server 104 may access the service data 103 and 105. The server 104 may also access the map data 107. The map data 107 may be further divided into map tiles. At least some of the service data 103 and 105 may reference one or more of the map tiles. For instance, a portion of the service data 103 may reference a first set of map tiles and a second map tile, where the second map tile encompasses the first set of map tiles. By referencing the first set of map tiles and the second map tile, the portion is associated to the map tiles.

The server 104 may assign the service data 103 and 105 to one or more map tiles based on a correspondence between the referenced map tiles and the one or more map tiles. The server 104 may divide the service data 103 and 105 into batches, where each batch is associated with the one or more map tiles. The server 104 may determine a specific map tile referenced by a portion of the service data 103 and/or the service data 105. The portion of the service data 103 and/or 105 may therefore be assigned to the batch corresponding to the specific map tile.

After assigning the service data 103 and 105 to batches according to the map tiles referenced by the service data 103 and 105, the server 104 may generate a service index 109. The service index 109 may be stored on the database 102. The service index 109 may include information about the batches containing the service data 103 and 105. For example, for each batch the service index 109 may include a batch ID, a size of the batch, a compressed size, and a map tile reference.

At some point, a user of the mobile device 108 may wish to have offline data associated with the geographic region. The mobile device 108 may the request the offline map data 106 from the server 104. In response, the server 104 may determine the batches corresponding to the map tiles by looking for the relevant map tile references in the service index 109. The server 104 may then access the appropriate batches and transmit the offline map data 106 (including the service data 103 and 105 in the appropriate batches and the map data 107) to the mobile device 108. Because the service data 103 and 105 is batched corresponding to the map tiles, the offline map data 106 may therefore represent the geographical region and include service data associated with the geographical region. The mobile device 108 may then store the offline map data 106. The mobile device 108 may later be in the geographical area without cellular service or some other way to connect to the server 104. Services such as the routing service and the search service may still perform actions relating to the geographical area, because the offline map data 106 is stored locally on the mobile device 108.

### II. Identifying Relevant Maps for use in Offline Mode

As discussed above, a mobile device may need to service data in order for certain services to function properly. Downloading service data for an entire county, state, country, etc. may enable services to function properly, by may include a large amount of unnecessary data. Downloading only that service data associated with an area where the mobile device is (or might be) may be of interest. Of that service data, only that service data associated with areas with poor wireless network coverage may be necessary. Thus, in order to efficiently provide service data to a mobile device, a destination and expected wireless network coverage thereof may be determined.

### A. Determining a Destination and Related Geographical Area

Determining map data to download for use in offline mode may include identifying a destination where a mobile device may be at some time in the future. The destination may be an end point of a route, an intermediate location, or a predicted future location. Information about the future whereabouts of the mobile device may therefore be determined before determining expected wireless network coverage at the destination location. If an area has low expected wireless network coverage, then the user device or the server can prompt to download or initiate automatic downloading of relevant map information for the area.

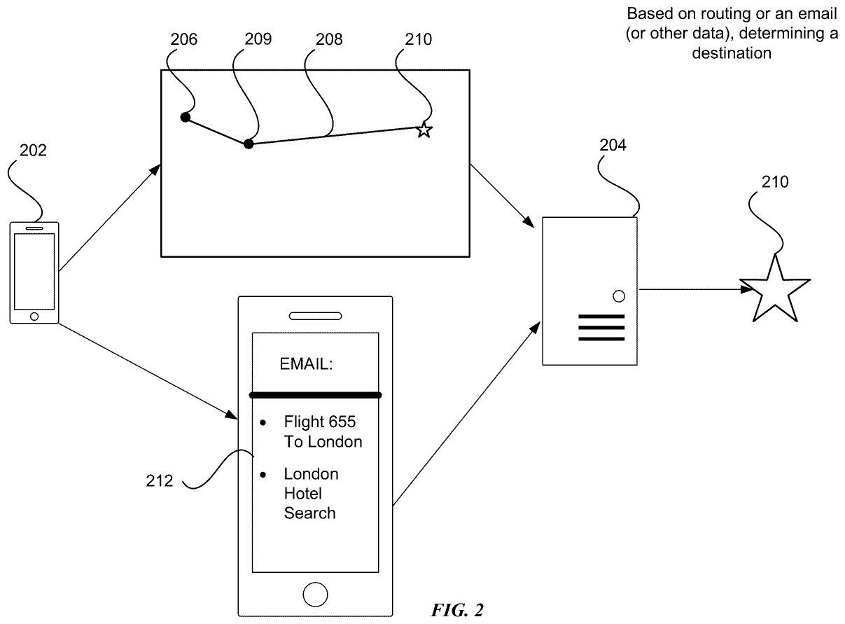

FIG. 2 illustrates a mobile device 202 determining a destination 210, according to at least one embodiment. The mobile device 202 may be similar to the mobile device 108 in FIG. 1. The mobile device 202 may therefore be a mobile phone smart phone, tablet, laptop, or other such device. A server 204 may be similar to the server 104 in FIG. 1, having access to a database and be in communication with the mobile device 202.

The mobile device 202 may determine a route 208 from a starting point 206 to the destination 210. The starting point 206 may be based on a user input in the mobile device 202 or based on a current location of the mobile device 202. The route 208 may be determined by a routing service. The routing service may run on the mobile device 202 or may be run on the server 204. The route 208 may include just the starting point 206 and the destination 210 or may include multiple intermediate locations. In other embodiments, the route 208 may be a portion of a larger route, and the destination 210 an intermediate point 209 along the larger route. The routing service may then transmit location data corresponding to some or all of the route 208, the destination 210 and/or any intermediate locations along the route 208 to the server 204. The server 204 may receive the location data and identify the destination 210 for further analysis.

For example, the destination 210 may be a national park and the intermediate point 209 may be a city alone the route 208. The server 204 may then determine information about the destination 210 and the intermediate point 209 such as activities performed by users at the destination 210 and the intermediate point 209 (e.g., hiking, dining, other activities), expected wireless network coverage, and other information.

Additionally or alternatively, the location data associated with the destination 210 may be determined via predictive data. The mobile device 202 may access data 212 associated with the mobile device. The data 212 may indicate the destination 210 of the mobile device 202. For example, the data 212 may be determined from one or more emails on the mobile device 202 and/or associated with an account of a user of the mobile device 202. The data 212 may also be accessed from a wallet, a calendar, or other suitable source associated with the user of the mobile device 202. In some embodiments, the mobile device 202 may the determine that the data 212 indicates that the destination 210 is in a country other than a country associated with the mobile device 202. The mobile device 202 may then display a prompt suggesting that the user download map data corresponding to the destination 210.

In another example, the predictive data may suggest that the destination 210 is in the same country as the country associated with the mobile device 202. The destination 210 may be determined from information showing a hotel reservation at a hotel in a national park. The intermediate point 209 may be determined from a hotel reservation at another city the day(s) prior to the reservation at the destination 210. The mobile device 202 may then transmit the location data associated with the destination 210 and the intermediate point 209 to the server 204. After receiving the location data, the server 204 may identify the destination for further analysis. The server 204 may then determine information about the destination 210 and the intermediate point 209 such as activities performed by users at the destination 210 and the intermediate point 209 (e.g., hiking, dining, other activities), expected wireless network coverage, and other information.

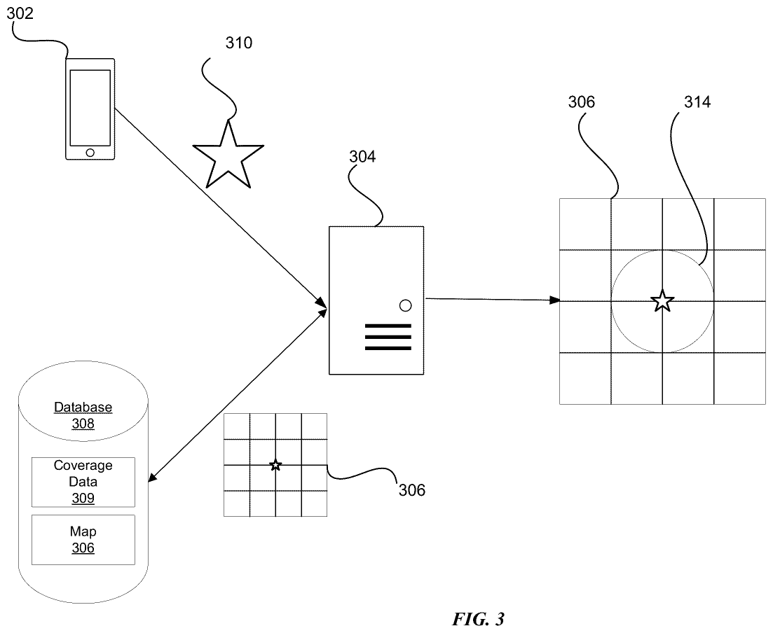

FIG. 3 illustrates a server 304 identifying a geographical area 314 associated with a destination 310, according to at least one embodiment. The server 304 may be similar to the server 204 described in FIG. 2. The destination 310 may be the destination 210 or any intermediate location identified by the mobile device 202 in FIG. 2. The server 304 may receive location data associated with the destination 310 from a mobile device 302. The mobile device 302 may include a mobile device or other user device such as a mobile phone, smartphone, tablet, laptop, or other suitable device. The server 304 may then retrieve a map 306 from a database 308 based at least in part on the location data. The map 306 may be similar to that included in the offline map data 106 in FIG. 1 and include one or more map tiles. The map 306 may represent the destination 310 and a surrounding region.

The server 304 may also access the coverage data 309 from the database 308. The coverage data 309 may include one or more historical coverage data points for each of the one or more map tiles in the map 306. Each historical network coverage data point may be based on location data from a respective mobile device. Each historical network coverage data point may indicate a location and a network status (either “in-service” or “out-of-service”). Additionally or alternatively, each historical network coverage data point may include a signal strength indicator (e.g., 1 bar, 2 bars, 3 bars, etc.). The location data may be determined by the respective mobile device via GPS data or other such data. The location data may alternatively be determined by a network provider triangulating a position of the mobile device using one or more cell towers.

For example, a first mobile device may have one bar of cellular service at a first location, and thus be in-service. The first mobile device may then send location data corresponding to the first location and a respective network status to a server. A second mobile device may have no bars at the first location and thus be out-of-service. The second mobile device may record location data corresponding to the first location (e.g., GPS coordinates) and save its network status. At a later time, when the second mobile device is in-service, the second mobile device may transmit the location data and respective network status to the server. The server may generate a respective historical coverage data point and cause the respective historical coverage data points to the database 308. The server may also associate the historical coverage data points with a map tile corresponding to the first location.

In some embodiments, only historical network coverage data points associated with a network provider of the mobile device 302 may be considered. For example, the location data provided to the server 304 may include data identifying the network provider accessed from a Subscriber Identity Module (“SIM card”) of the mobile device 302 with the location data. The server 304 may therefore only access historical network coverage data points associated with a network provider of the mobile device 302. In some embodiments, the mobile device 302 may include multiple SIM cards. In that case, the server 304 may access historical network coverage data points associated with the network providers of each SIM card of the mobile device 302. In other embodiments, the server 304 may access historical network coverage data points for multiple network providers. In another embodiment, the server may access historical network coverage data points associated with a second network provider.

A geographical area 314 is shown within the map 306 at a relatively high zoom level. The geographical area 314 may therefore include a subset of the one or more map tiles included in the map 306. The geographical area may be a circle with a specified radius about the destination 310 (e.g., 10 km) or any other region defined about the destination 310 (e.g., a square). In some embodiments, the server 304 may use information about the destination 310 to determine the geographical area 314 about the destination 310. For instance, the destination 310 may be a hotel in a national park. The server 304 may determine that users that visit the national park and/or the hotel often hike in a wide area around the hotel. This determination may be based on historical data from other users, predictive data such as a search history, or other suitable methods. The server 304 may therefore determine the geographical area 314 be larger-than-average (e.g., 15 km around the destination 310). In another example, the destination 310 may be a location within a town or city. The geographical area 314 may then be smaller-than-average (e.g., 1 km).

In some embodiments, the geographical area 314 may be determined based on a user input on the mobile device. For example, user may specify the geographical area 314 via the mobile device 302 and transmit information identifying the geographical area 314 along with the location data. In other embodiments, the geographical area 314 may be determined by a predetermined parameter such as a 10 km radius about the destination 310. The predetermined parameter may alternatively be a square, rectangle, or any other shape about the destination 310. In yet other embodiments, the geographical area 314 may be pre-determined based upon the destination 310. For example, a location inside a national park may automatically be used to generate a larger geographical area 314, whereas a location in a city may generate a smaller geographical area 314.

The server 304 may combine the coverage data 309 with the map 306. In some embodiments, the server 304 may just access a portion of the map 206 and the coverage data 309 corresponding to the geographical area 314. In other embodiments, the server 304 may access a larger portion of the map 206 and the coverage data 309.

Determining the geographical area 314 may identify an area that may need to be downloaded, but more information may be needed. If the mobile device 302 is connected to a network while in the geographical area 314, there may be no need to download the map 306. Therefore, the server 304 may determine a likelihood that the mobile device will be connected in the geographical area 314.

### B. Grid-Based Analysis for Network Coverage

Once the geographical area is determined, a total expected wireless network coverage level may be determined for the geographical area. The total expected wireless network coverage level may be determined from cellular network coverage data of a network provider associated with the mobile device, cellular network coverage data of other network providers in the geographical area, roaming/service partnerships between various network providers, and other such data. The total expected wireless coverage may represent a likelihood that a mobile device will be able to connect to a wireless network. The total expected wireless coverage may be represented as an average number of network bars in the geographical area, a percentage of map tiles representing the geographical area that have sufficient coverage, or other such metrics. If the total expected wireless network coverage level for the geographical area is above a threshold, there may be no need to download map data. Additionally or alternatively, if the total expected wireless network coverage level in the geographical area is below the threshold in only a portion of the geographical area, only the portion of the geographical area may be downloaded. If total expected wireless network coverage level for the geographical area is below the threshold, the map data may be needed for various map services to function properly. To determine the total expected wireless network coverage level, an expected wireless network coverage of map tiles corresponding to the geographical area may be determined.

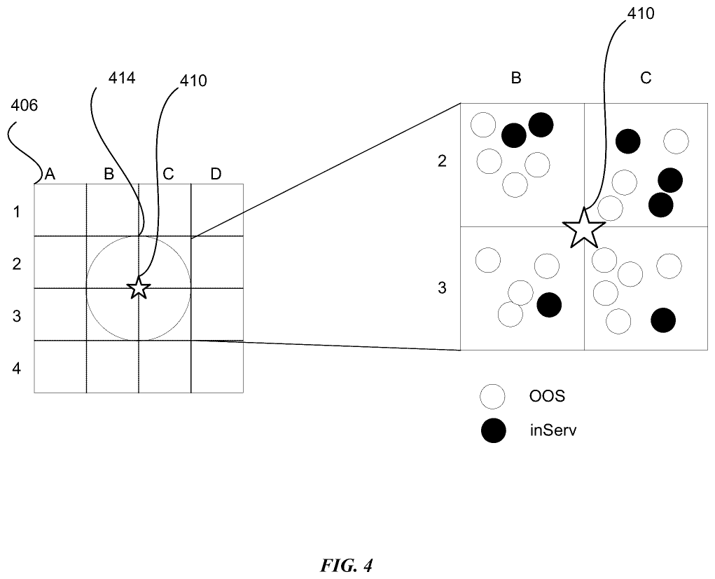

FIG. 4 illustrates an expected wireless network coverage of a geographical area 414, according to at least one embodiment. The geographical area 414 may be similar to the geographical area 314 in FIG. 3, and therefore be defined as a region around a destination 410. The geographical area 414 may also be some or all of a map 406 and encompass one or more map tiles.

In relation to FIG. 4, the geographical area 414 may encompass some or all of map tiles B2, B3, C2, and C3. The server may analyze each of the set of map tiles B2-C3 to determine an expected wireless network coverage level. To determine the expected wireless network coverage, the server may access one or more historical network coverage data points for each map tile B2-C3, such as the historical coverage data points described in FIG. 3. The computing device may then determine the expected wireless network coverage for each tile by combining all of the historical network coverage data points in a given map tile.

In some embodiments, only historical network coverage data points associated with a network provider of the mobile device 302 may be considered. For example, the location data provided to the server may include data identifying the network provider accessed from a Subscriber Identity Module (“SIM card”) of the mobile with the location data. The server may therefore only access historical network coverage data points associated with a network provider of the mobile device. The expected wireless network coverage may therefore be based only on the network provider of the mobile device. In other embodiments, the server 304 may access historical network coverage data points for multiple network providers. In another embodiment, the server may access historical network coverage data points associated with a second network provider and infer an expected wireless network coverage therefrom.

Each map tile B2-C3 may have one or more historical network coverage data points within. For example, the map tile B2 may have six historical network coverage data points. The map tile B3 may have five historical network coverage data points. The map tile C2 may have six historical network coverage data points. The map tile C3 may have six historical network coverage data points.

In analyzing each map tile B2-C3, the server may determine that the map tile B2 includes four out of service historical network coverage data points and two in-service historical network coverage data points (33% coverage). The map tile B3 may include four out of service historical network coverage data points and one in-service historical network coverage data points (20% coverage). The map tile C2 may include three out of service historical network coverage data points and three in-service historical network coverage data points (50% coverage). The map tile C3 may include five out of service historical network coverage data points and one in-service historical network coverage data points (17% coverage).

The server may then generate a total expected wireless network coverage level of the geographical area. In some embodiments, the server may combine the expected wireless network coverage to generate the total expected wireless network coverage level. For example, the server may take an average of the expected wireless network coverages of each of the map tiles B2-C3. In this case, the average may be 30% expected wireless network coverage. The average may then be compared to a predetermined area coverage threshold (e.g., 20%, 25%, 30%, 40% etc.). If the average is below the predetermined area coverage threshold, the server may provide map data associated with the geographical area to the mobile device or provide a prompt to download the map data associated with the geographical area.

In another example, the server may compare the expected wireless network coverages of each of the map tiles B2-C3 to a per-tile threshold, such as 30% expected wireless network coverage in each tile. The server may then compare the expected wireless network coverage of each map tile B2-C3 to the threshold. If a certain percentage (e.g., less than 50%) of the map tiles B2-C3 have expected wireless network coverages that are below per-tile threshold, the server may provide the map data or provide a prompt to download the map data. In the example shown in FIG. 3, two of the four map tiles are below 30% expected wireless network coverage. Thus, in this case, the server may not prompt the mobile device to download the map data.

### C. Flowchart for Providing a Download Recommendation

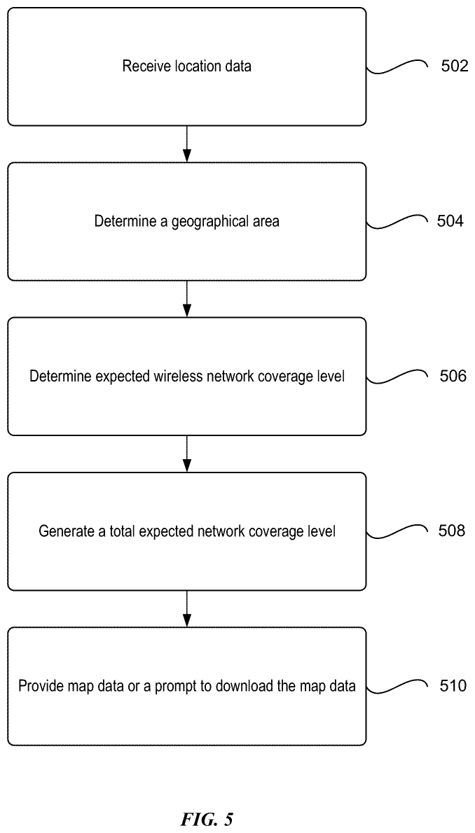

FIG. 5 illustrates a flowchart of a method 500 for providing a download recommendation, according to at least one embodiment. The method 500 may be performed by some or all of the devices described herein, such as the mobile device 202 and the server 204 in FIG. 2. In some embodiments, some or all of the steps may be performed by systems or devices not other than the mobile device 202 and the server 204. Additionally, some or all of the steps may be performed in a different order than that shown in the method 500. In some embodiments, some of the steps may not be performed.

At step 502, a computing device may receive location data associated with a destination location of a mobile device. The computing device may be a server. The location data may be generated as a result of a routing service performed by the mobile device and/or the server. The destination location may be a final destination or an intermediate location along a route. Additionally or alternatively, the location data may be generated in response to other data on the mobile device, such as email(s), calendar information, wallet information, or other such information.

At step 504, the computing device may determine a geographical area associated with the destination location. The geographical area may be defined around the geographical area by a radius or some other measure. For example, the geographical area may be a square or other shape about the destination location.

In some embodiments, the geographical area may be determined at least in part on the destination location. For example, two different destination locations may result in geographical areas of different sizes. A destination location corresponding to a national park may have a larger-then-average geographical region, while a destination location corresponding to a city may have a smaller-than-average geographical region. The geographical area for a particular destination location may be based in part on location data from other mobile devices.

At step 506, the computing device may determine an expected wireless network coverage level for each of a set of map tiles. The set of map tiles may correspond to the geographical area, such as the map tiles B2-C3 in FIG. 5. Determining the expected wireless network coverage may include determining a network provider associated with the mobile device. For example, the mobile device may include data identifying a network provider from a Subscriber Identity Module (“SIM card”) of the mobile with the location data.

Determining the expected wireless network coverage may also include accessing one or more historical network coverage data points for each of the set of map tiles corresponding to the geographical area. In some embodiments, the one or more historical network coverage data points may be associated with the network provider. In other embodiments, the computing device may access one or more historical network coverage data points for one or more network providers.

The one or more historical network coverage data points may be crowd sourced. For example, each historical network coverage data point may be based on location data from a respective mobile device. Each historical network coverage data point may indicate a location and a network status (either “in-service” or “out-of-service”) or other examples described herein. The computing device may then determine the expected wireless network coverage for each tile by combining all of the historical network coverage data points in a given map tile.

At step 508, the computing device may generate a total expected network coverage level by combining the expected network coverage level of each of the set of map tiles. In some embodiments, the computing device may take an average of the expected wireless network coverages of each of the map tiles. The average may then be compared to a predetermined area coverage threshold (e.g., 20%, 25%, 30%, 40% etc.). If the average is below the predetermined area coverage threshold, the computing device may provide map data associated with the geographical area to the mobile device or provide a prompt to download the map data associated with the geographical area.

In other embodiments, the computing device the computing device may generate the total expected network coverage level by comparing the expected wireless network coverages of each of the map tiles to the predetermined threshold. The computing device may then compare the expected wireless network coverage of each map tile to the predetermined per-tile threshold. If a certain percentage (e.g., less than 50%) of the map tiles have expected wireless network coverages that are below predetermined per-tile threshold, the computing device may provide map data or provide a prompt to download the map data to the mobile device.

In some embodiments, the computing device may access only the historical network coverage data points associated with the network provider identified by the mobile device. In other embodiments, the computing device may access historical network coverage data points for multiple network providers. The computing device may then generate the total expected wireless network coverage level based upon all network providers, not just the one provided by the mobile device. In another embodiment, the computing device may access historical network coverage data points associated with a second network provider and infer a total expected wireless network coverage level therefrom.

At step 510, the computing device may provide map data to the mobile device. Additionally or alternatively, the computing device may provide a prompt to the mobile device to download the map data. The map data may include geographical information relating to a position, latitude and longitude, graphical map data, and other such information. The map data may also include service data relating to one or more services. The one or more services may include a routing service, a search service, and other such services. The service data may be correlated to the geographical information, e.g., associated with one or more map tiles similar to the map tiles B2-C3 in FIG. 4.

### III. Efficient Batching of Map Tiles

The efficient delivery and storage of map data may include batching data with geographical information. For instance, services like a search service, a routing service, and a vector tiles service may all have different data sets (collectively, “service data”). Batching all of the data together with the map data may reduce the number of downloads a device performs (e.g., one download for all map data instead of a download per service), but also may lead to other issues. For example, each service may associate their respective service data with a geographical area or location, but that association may differ from the associations of other respective service data.

Some service data may be associated with multiple geographical areas. When the service data is batched with the map data, duplicates may occur. For instance, a map (and therefore map data) may have different zoom levels. A high zoom level may increase the focus on a particular region of the map, and thus a map tile would represent a relatively small area. (e.g., a 10 meter square). A low zoom level, by contrast, may represent a larger area (e.g., a 10 KM square). Service data may sometimes be associated with a geographical region at more than one zoom level. Service data corresponding to a road, for instance, may be associated with multiple map tiles within a geographical region at multiple zoom levels (e.g., zoom levels 1-20). Service data corresponding to a building may still be associated with map tiles at multiple zoom levels, but less than that of the road (e.g., levels 1-15). The service data corresponding to the building may also be more localized; a building may not span multiple geographical regions.

When providing map and service data, the services relying on that data may need to operate at multiple zoom levels. If a batch of service data was downloaded for every map tile at every zoom level, a complete set of service data may be accessible by the services. The complete set of service data may include large amounts of duplicate data, however. To address this, duplicate service data may be removed such that only one instance of the service data is downloaded.

### A. Map Services

Many services may use maps or map data. These services may include a vector tiles service, a search service, a routing service, and other such services. Vector tile service data may include geographic data about a geographical region. The vector tile service data may be organized into map tiles at various zoom levels and allow a user to see detail within a map application about the geographical region. Search service data may include information about one or more objects within a geographic region, an area applicable to a search index, and other such information. The search service data may also reference a map tile or map tiles at one or more zoom levels. Routing service data may include traffic data, construction data, or other travel-related data to plan a route from one destination to another. Routing service data may also include wireless network coverage information, such as the historical network coverage data points described in FIG. 3. In some embodiments, the wireless network coverage information may be included with other service data and/or separately from any service data. A road, for example, may reference multiple map tiles at the same and/or multiple zoom levels. The wireless network information may be associated with map tiles at another zoom level. Thus, routing service data may be reference and be associated with map tiles at one or more zoom levels. Other services may have still other links and organizational structures. Therefore, in order to provide the service data efficiently, all service data may be correlated to map tiles at the same zoom level and duplicate data removed.

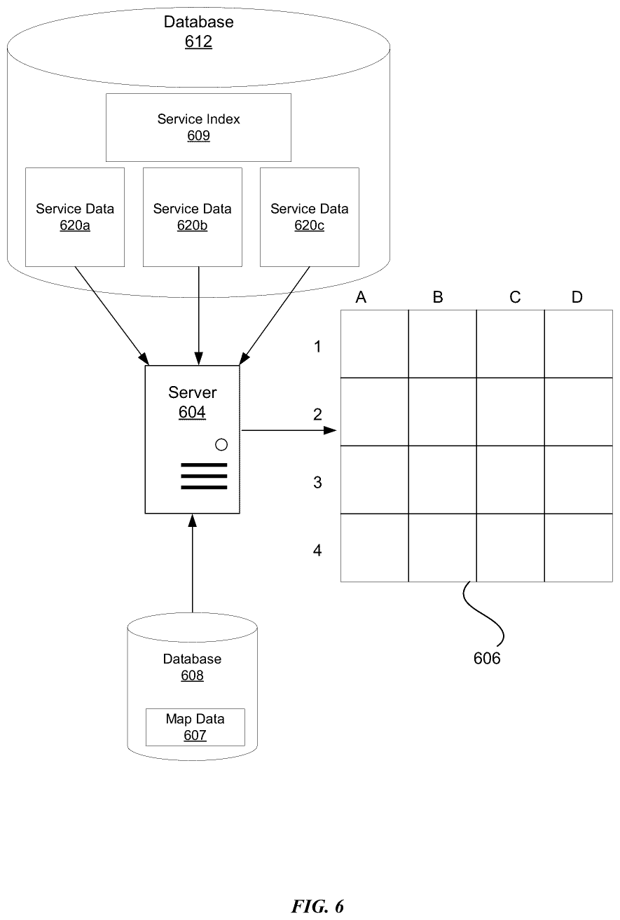

FIG. 6 illustrates a server 604 accessing service data 620a-c and a map 606, according to at least one embodiment. The server 604 may be the server 304 in FIG. 3 or may be another computing device within a computing system including the server 304. The map 606 may be similar to the map 306, but as no destination has been specified, there may be no geographical area specified. The service data 620a-c may be associated with one or more services that utilize the map 306 or other map data (e.g., the routing service, the vector tiles service, the search service, or other such service).

The server 604 may access map data 607 from a database 608. The database 608 may be similar to the database 102 in FIG. 1. The map data may include the map 606. The map 606 may include geographical information about a geographical area and be organized into map tiles A1-D4 at a zoom level. The server 604 may also access the service data 620a-c from a database 612. Although only one database 612 is shown, each of the service data 620a-c may be stored on a respective database. In other embodiments, some or all of the service data 620a-c may be stored on the database 608 with the map data 607. The service data 620a-c may be a set key/value pairs. Each key may be a service-specific reference to a particular portion of the service data 602a-c. The value may include the particular portion of the service data 620a-c. Each key/value pair may also include a reference to a particular map tile.

The service data 620a-c may be associated with a geographical region generally represented by the map 606, but the service data 620a-c may not refer only to the map tiles A1-D4. For example, the service data 620a may be the routing service data. The service data 620a may therefore include information about a road. The information about a road may refer to several map tiles besides the map tiles A1-D4. While the information about the road may also refer to one or more of the map tiles A1-D4, the service data 620a include information not relevant to the map tiles A1-D4.

Some of the service data may already be organized according to the map tiles A1-D4. For example, the service data 620b may be the vector tiles service data. The service data 620b may therefore include data correlating to map tiles the zoom level represented in the map 606. The service data 620b may also include data correlating to map tiles at a different level that of the map 606.

The server 604 may assign some or all of the service data 620a-c to one or more of the map tiles A1-D4. In the example of the routing service, the server 604 may determine a portion of the service data 620a that references a map tile of the map tiles A1-D4. The server 604 may then assign portions of the service data 620a to a respective map tile A1-D4. In another example, the server 604 may determine one or more map tiles that correspond to the area included in a search index. The search service data may therefore be assigned to respective corresponding map tiles. If some or all of the service data 620a-c is organized according to the map tiles A1-D4, the server 604 may associate the service data 620a-c directly with the appropriate map tile. If the service data 620a-c is not organized according to the map tiles A1-D4, the server 604 may map the service data 620a-c to the appropriate map tile A1-D4.

### B. Generation of Initial Batches of Service Data

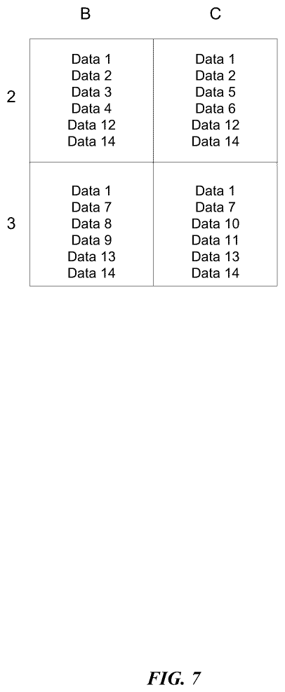

FIG. 7 illustrates data organized into initial batches B2-C3, according to at least one embodiment. The initial batches B2-C3 may correspond to map tiles B2, B3, C2, and C3 of the map 606 in FIG. 6. It should also be understood that although only four batches B2-C3 are shown in FIG. 7, the following description may apply to any batch or map tile (e.g., the map tile A1 in FIG. 6). Each portion of data 1-14 may represent a key/value pair. For example, data 1 may represent a service-specific key that identifies a portion of service data used by a particular service. The data 1 and/or the portion of the service data may also include a reference to one or more map tile(s) (in the example shown in FIG. 7, the map tiles B1-C3).

The initial batches B2-C3 may include data 1-11. The data 1-11 may be assigned to one or more of the initial batches B2-C3 by a server such as the server 604 in FIG. 6. The data 1-11 may be some or all of the service data 620a-c, where each of the data 1-11 is associated with a geographical area corresponding to the map tiles B2-C3 in FIG. 6. Because the initial batches B2-C3 may correspond to the map tiles B2-C3, the service data 620a-c relevant to the geographical area may now be organized according to the map tiles B2-C3.

For example, the data 1 may be data related to a road that passes through the regions represented map tiles B2-C3. The data 1 may therefore include one or more coordinates found within the map tiles B2-C3. The server may then assign the data 1 to each of the map tiles B2-C3. Hence, the data 1, being a component of the service data 620a-c may now be organized according to the map tiles B2-C3.

In another example, the data 2 may be associated with a search index that returns objects within a map tile of a lower zoom level that includes the map tiles B2 and C2. Because the search index may be relevant to both the map tiles B2 and C3, the initial batches B2 and C3 may both include data 2. Thus, even though the service data comprising the data 2 may have been organized differently than the map tiles B2-C3 (e.g., associated with a map tile of a lower zoom level), the data 2 and related service data is now organized according to the map tiles B2-C3.

In some embodiments, the map tiles B2-C3 in FIG. 7 may correspond to the map tiles B2-C3 in FIG. 4 used to determine the expected wireless network coverage. If coverage is low, then the map tiles B2-C3 can be downloaded or a prompt to ask the user about downloading those map tiles. Thus, the initial batches B2-C3 identified for downloading may correlate to the map tiles B2-C3 used to determine the expected wireless network coverage in FIG. 4.

### C. Zoom Levels and Redundancy of Data

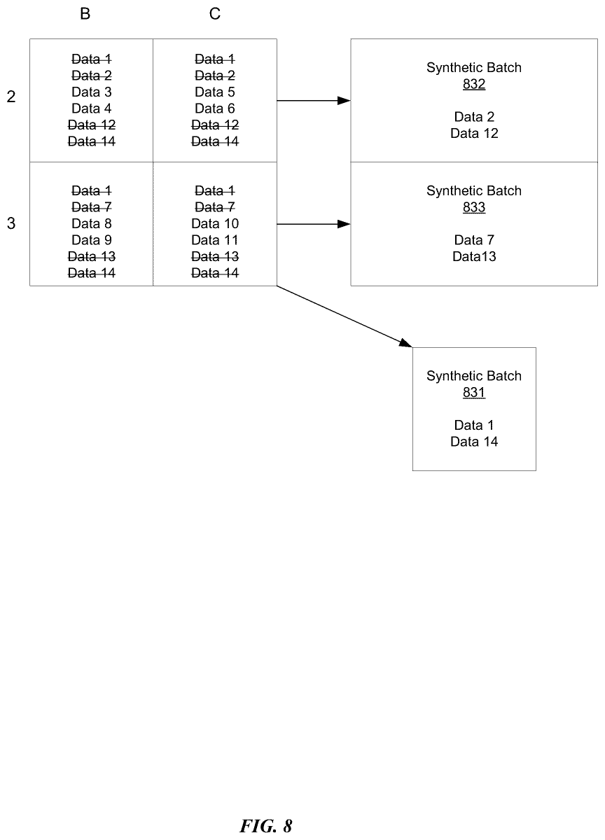

FIG. 8 illustrates synthetic batches 831-833 including duplicate data removed from initial batches B2-C3, according to at least one embodiment. The initial batches B2-C3 may be the initial batches B2-C3 in FIG. 7, and therefore include the data 1-11. At least some of the data 1-11 may be duplicated in the initial batches B2-C3. For example, data 1 may be associated with a search index of the search service. The search index may include a “near me” parameter that conducts a search to a radius around a location of a mobile device. In terms of the search index, large portions of data may be duplicated within the initial batches B2-C3, as all of the map tiles B2-C3 are adjacent. The large portions of data may be returned in a “near me” search from any of the map tiles B2-C3. The data 1 may therefore represent the large portions of data and be shared with all the initial batches B2-C3.

In another example, the data 1 may represent service data duplicated at multiple zoom levels. For example, the data I may represent a park within the geographical region represented by the map tiles B2-C3 at the zoom level. If the zoom level is decreased, such that the map tiles B2-C3 are collapsed into a single map tile, data 1 may still apply to the single map tile at the lower zoom level. The lower zoom level may therefore be the max zoom level for the data 1 and/or the service data including the data 1. In effect, then, the data 1 may be unnecessarily duplicated four times in the initial batches B2-C3 because the zoom level is higher than the max zoom level.

Duplicated data, either due to adjacent tiles, max zoom level, or other reasons, may be removed from the initial batches B2-C3 by deduplication and put into synthetic batches. The data 1 and 14 may be duplicated in all of the initial batches B2-C3. The data 1 and 14 may therefore be removed from all of the initial batches B2-C3 and put into a synthetic batch 831. The synthetic batch 831 may include metadata that indicates that the data 1 and the data 14 are associated with the batches B2-C3 and/or the map tiles B2-C3.

The data 2 and the data 12 may be duplicated in initial batches B2 and C2. The data 2 and 12 may be removed from the map tiles B2 and C2 and be included in a synthetic batch 832. The synthetic batch 832 may include metadata that indicates that the data 2 and 12 are associated with the initial batches B2 and C2 and/or the map tiles B2 and C2. Similarly, the data 7 and 13 may be duplicated in the initial batches B3 and C3. The data 7 may be removed from the initial batches B3 and C3 and included in a synthetic batch 833. The synthetic batch 833 may include metadata that indicates that the data 7 are associated with the initial batches B3 and C3 and/or the map tiles B2-C3. Thus, any duplicate data may be removed from the initial batches and included in one or more synthetic batches. While the number of batches to download may increase, as duplicate data is being removed, each batch may be more efficient to deliver and/or store.

Although FIG. 8 illustrates initial batches for a single zoom level being deduplicated, there may be initial batches created for including service data for each zoom level. For example, the map tiles B2-C3 may be map tiles at zoom level 4 (sometimes “level 4 map tiles”). The geographic region represented by the level 4 map tiles may include map tiles of a different zoom level, such as zoom level 5. Each level 5 map tile may represent a smaller component of the geographical region represented by the level 4 map tiles.

Service data for the geographic region may be associated with both the level 4 map tiles and the level 5 map tiles. Some of the service data associated with the level 5 map tiles may be duplicated in the service data associated with the level 4 map tiles, while other service data associated with each zoom level may differ. Initial batches for the zoom levels 4 and 5 may therefore contain duplicate data. In order to efficiently deliver the initial batches of both the zoom level, the duplicate data across different zoom levels may be removed from the initial batches for the different zoom levels and assigned to synthetic batches.

In some embodiments, two or more synthetic batches may also include a second set of shared data. The second set of shared data may then be removed and placed into a new synthetic batch. The different synthetic batch may then contain metadata that indicates the second set of shared data is relevant to the two or more synthetic batches. This deduplication may be iteratively performed within a hierarchal structure until no initial or synthetic batches contain duplicate data, e.g., for a given zoom level.

### D. Identification of Batches Corresponding to Geographical Area (These Sections can Have System Diagrams if you Think it Would be Useful)

All of the actions and processes described in FIGS. 6-8 may occur at some point before a mobile device requests map data (including service data) for download. Accessing and assigning the service data to map tiles may be inefficient to perform whenever a mobile device requests map data. Thus, batches of map data associated with multiple geographical regions may be stored and only those batches corresponding to a requested area may be provided for download.

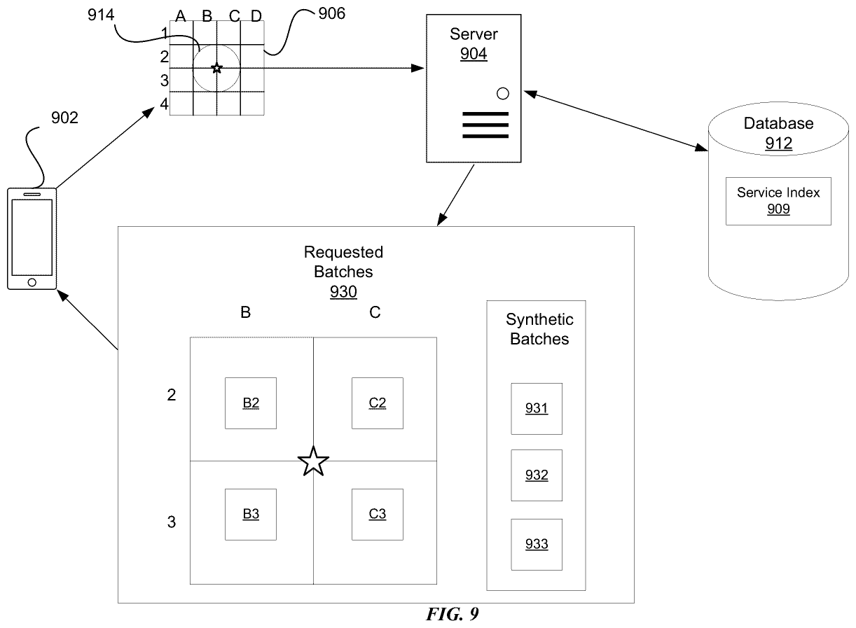

FIG. 9 illustrates a simplified diagram of a server 904 providing requested batches 930 to a mobile device 902, according to at least one embodiment. The mobile device 902 may be similar to the mobile device 202 in FIG. 2. The server 904 may be similar to the server 204 in FIG. 2 and/or the server 604 in FIG. 6. As such, the server 904 may perform some or all of the functions and processes described in relation to FIGS. 1-8. A database 912 may be similar to the database 102 in FIG. 1 and include service data associated with one or more services and/or batches of map data including the service data (as described in FIG. 8). The database 912 may include batches associated with each of the map tiles A1-D4 of a map 906. The database 912 may also include a service index 909. The service index 909 may include information about the batches associated with the map tiles A1-D4. For example, for each batch the service index 909 may include a batch ID, a size of the batch, a compressed size, and a map tile reference.

The mobile device 902 may request a download of map data corresponding to a geographical area 914 included in the map 906. In some embodiments, the geographical area 914 may be identified in response to a user input on the mobile device 902. The request may be transmitted in response to a prompt to download map data received by the mobile device 902. The prompt may have been received based on a routing request or based on data on the mobile device 902. A user may then determine the geographical area 914 around a destination location. In other embodiments, the prompt to download the map data may include an automatically configured geographical area 914. For example, the geographical area 914 may be defined by a radius (or other shape) about the destination, as is described in FIGS. 1-5.

The geographical area 914 may correspond to a set of map tiles of the map 906. Here, the geographical area 914 may correspond to the map tiles B2-C3. Although only a portion of the map tiles B2-C3 may be within the border of the geographical area 914, map data associated with each map tile B2-C3 may be requested by the mobile device 902.

The server 904 may receive the request for map data associated with the map tiles B2-C3. As described in FIG. 8, the map tiles B2-C3 may be correspond to one or more initial batches. In response to the request, the server 904 may identify initial batches B2-C3 via the service index 909 that correspond to the map tiles B2-C3. The server 904 may also identify synthetic batches 931-933 that are associated with the initial batches B2-C3 (together, the “requested batches 930”). The server 904 may then access the requested batches 930 from the database 912. Because the database may include batches corresponding to all of the map tiles A1-D4, the requested batches 930 may therefore be a subset of the batches stored on the database 912.

The requested batches 930 may include the initial batches B2-C3 and synthetic batches 931-933. The initial batches B2-C3 may be similar to the initial batches B2-C3 in FIG. 8. Similarly, the synthetic batches 931-933 may be similar to the synthetic batches 831-833 and include the set of duplicate data removed from the initial batches B2-C3. Each of the synthetic batches 831-833 may also include metadata that identifies one or more initial batches to which the duplicate data applies. The server 904 may then provide the requested batches to the mobile device 902.

### E. Flowchart of Batching Data for Offline Download

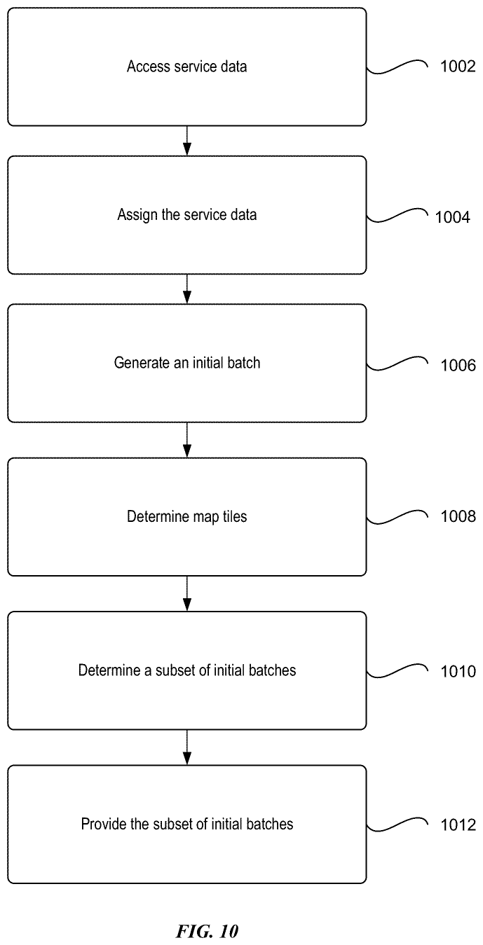

FIG. 10 illustrates a flowchart of a method 1000 for batching data for offline download, according to at least one embodiment. The method 1000 may be performed by some or all of the devices described herein, such as the mobile device 902 and the server 904 in FIG. 10. In some embodiments, the some or all of the steps may be performed by systems or devices other than the mobile device 902 and the server 904. Additionally, some or all of the steps may be performed in a different order than that shown in the method 1000. In some embodiments, some of the steps may not be performed.

At step 1002, a computing device may access service data associated with a service. The service data may also be associated with a group of geographical regions. The service data may include data for use by a routing service, a vector tiles service, a search service, or any other such service. The service may be run on a mobile device or run on a server and accessed by the mobile device.

At step 1004, for each of a set of map tiles, the computing device may assign at least some of the service data of the group of geographical regions corresponding to the map tile. The map tile may be a subdivision of a map at a first zoom level. The at least some service data may be associated with geographical region represented by the map tile but may be represented at a different zoom level. The computing device may determine one or more map tiles at the first zoom level that correspond to the geographical region at the second zoom level and assign the at least some service data to the one or more map tiles.

At step 1006, the computing device may generate an initial batch of service data corresponding to the map tile, thereby generating initial batches of service data. The initial batches of service data may therefore correlate to the set of map tiles. In some embodiments, the service data may include data for multiple services. The service data for each respective service may be assigned to a map tile at the first zoom level. In other words, all of the service data for all of the services may be assigned to the same map tiles. In other embodiments, the service data for each respective service may be assigned to a map tile at some other zoom level. The service data for each respective service may therefore be organized differently than the service data for any other respective service.

At step 1008, the computing device may receive a request to download map data corresponding to a geographical area from a user device. In some embodiments, the geographical area may be generated in response to a user action. For example, the user device may display a prompt to download map data due to poor expected wireless network coverage at and/or around a destination. The user may then select the geographical area around the destination for which to request map data. The mobile device may then transmit information to the computing device indicating the geographical area.

In other embodiments, the geographical area may be automatically generated. For example, a routing service may have performed a routing operation on the mobile device. The destination and/or one or more intermediate points along the route may be determined to have poor expected wireless network coverage. A computing device may then determine the geographic area around the destination and/or the intermediate points. The other computing device may then send a prompt to the mobile device to download map data for the geographical area. In response to an input corresponding to the prompt, the mobile device may request the map data for the automatically generated geographical area.

At step 1010, the computing device may determine one or map tiles that correspond to the geographical area. At step 1012, the computing device may determine a subset of the initial batches. Each initial batch of the subset of initial batches may correspond to a respective map tile representing the geographical area identified in the request.

In some embodiments, as part of determining the initial batches, the computing device may determine an expected wireless network coverage level associated with each of the one or more map tiles associated with the geographic area. The expected wireless network coverage level may be determined from one or more historical network coverage data points, as described in FIG. 3. The computing device may then generate a total expected wireless network coverage level by combining the expected wireless network coverage level of each map tile. The computing device may then compare the total expected wireless coverage level to a predetermined threshold, such as the per-tile threshold and or the predetermined area coverage threshold, as described in FIG. 4.

At step 1014, the computing device may provide the subset of initial batches to the mobile device, responsive to the request.

In some embodiments, the computing device may additionally determine that two or more of the initial batches include a set of shared data. The set of shared data may be service data from one or more services such as the routing service, the vector tile service, the search service, or some other such service. The two or more initial batches may be associated with adjacent map tiles. The shared data may therefore be data shared between the two adjacent map tiles. The shared data may be data associated with a particular zoom level.

The computing device may then generate a synthetic batch include the set of shared data. The synthetic batch may also include metadata that associates the synthetic batch and/or the shared data with each of the two or more initial batches. The synthetic batch may therefore be associated with each map tile associated with each of the two or more initial batches. The computing device may then remove the set of shared data from the two or more initial batches.

The computing device may then determine that the synthetic batch corresponds to the geographical area of the request, based at least in part in the metadata. The computing device may then provide the synthetic batch to the mobile device responsive to the request. The synthetic batch may be provided with the subset of initial batches.

### IV. Example Device

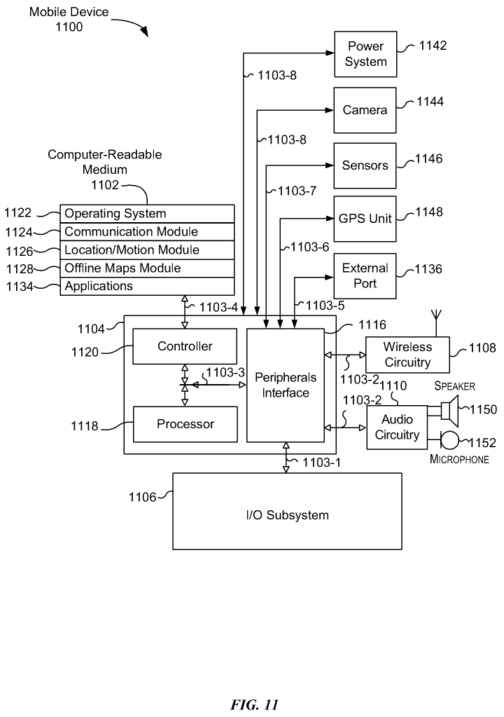

FIG. 11 is a block diagram of an example electronic device 1100 according to at least one embodiment. Device 1100 generally includes computer-readable medium 1102, a processing system 1104, an Input/Output (I/O) subsystem 1106, wireless circuitry 1108, and audio circuitry 1110 including speaker 1112 and microphone 1114. These components may be coupled by one or more communication buses or signal lines 1103. Device 1100 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.
it should be apparent that the architecture shown in FIG. 11 is only one example of an architecture for device 1100, and that device 1100 can have more or fewer components than shown, or a different configuration of components. The various components shown in FIG. 11 can be implemented in hardware, software, or a combination of both hardware and software, including one or more signal processing and/or application specific integrated circuits.

Wireless circuitry 1108 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1108 can use various protocols, e.g., as described herein. In various embodiments, wireless circuitry 1108 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 602.11a, IEEE 602.11b, IEEE 602.11g and/or IEEE 602.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1108 is coupled to processing system 1104 via peripherals interface 1116. Peripherals interface 1116 can include conventional components for establishing and maintaining communication between peripherals and processing system 1104. Voice and data information received by wireless circuitry 1108 (e.g., in speech recognition or voice command applications) is sent to one or more processors 1118 via peripherals interface 1116. One or more processors 1118 are configurable to process various data formats for one or more application programs 1134 stored on medium 1102.

Peripherals interface 1116 couple the input and output peripherals of device 1100 to the one or more processors 1118 and computer-readable medium 1102. One or more processors 1118 communicate with computer-readable medium 1102 via a controller 1120. Computer-readable medium 1102 can be any device or medium that can store code and/or data for use by one or more processors 1118. Computer-readable medium 1102 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 1116, one or more processors 1118, and controller 1120 can be implemented on a single chip, such as processing system 1104. In some other embodiments, they can be implemented on separate chips.

Processor(s) 1118 can include hardware and/or software elements that perform one or more processing functions, such as mathematical operations, logical operations, data manipulation operations, data transfer operations, controlling the reception of user input, controlling output of information to users, or the like. Processor(s) 1118 can be embodied as one or more hardware processors, microprocessors, microcontrollers, field programmable gate arrays (FPGAs), application-specified integrated circuits (ASICs), or the like.

Device 1100 also includes a power system 1142 for powering the various hardware components. Power system 1142 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1100 includes a camera 1144. In some embodiments, device 1100 includes sensors 1146. Sensors can include accelerometers, compass, gyrometer, pressure sensors, audio sensors, light sensors, barometers, and the like. Sensors 1146 can be used to sense location aspects, such as auditory or light signatures of a location.

In some embodiments, device 1100 can include a GPS receiver, sometimes referred to as a GPS unit 1148. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1118 run various software components stored in medium 1102 to perform various functions for device 1100. In some embodiments, the software components include an operating system 1122, a communication module 1124 (or set of instructions), a location module 1126 (or set of instructions), an offline maps module 1128 that is used as part of downloading offline maps as described herein, and other application programs 1134 (or set of instructions).

Operating system 1122 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1124 facilitates communication with other devices over one or more external ports 1136 or via wireless circuitry 1108 and includes various software components for handling data received from wireless circuitry 1108 and/or external port 1136. External port 1136 (e.g., universal serial bus (USB), FireWire, Lightning connector, 60-pin connector, etc.) is adapted for coupling directly to other devices or indirectly over a network (e.g., the Internet, wireless local area network (LAN), etc.).

Location/motion module 1126 can assist in determining the current position (e.g., coordinates or other geographic location identifiers) and motion of device 1100. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1126 receives data from GPS unit 1148 and analyzes the signals to determine the current position of the mobile device. In some embodiments, location/motion module 1126 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1108 and is passed to location/motion module 1126. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1100 based on the position coordinates of the corresponding transmitters. Regardless of the specific location technology used, location/motion module 1126 receives information from which a location fix can be derived, interprets that information, and returns location information, such as geographic coordinates, latitude/longitude, or other location fix data.

The offline maps module 1128 may send and/or receive map and/or service data messages to/from an antenna, e.g., connected to wireless circuitry 1108. The map and or service data may be used by one or more services, including a routing service, a vector tiles service, a search service, and other such services. The offline maps module 1128 can exist on various processors of the device, e.g., an always-on processor (AOP), a UWB chip, and/or an application processor.

The one or more applications 1134 on device 1100 can include any applications installed on the device 1100, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1106 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1106 can include a display and user input devices such as a keyboard, mouse, and/or trackpad. In some embodiments, I/O subsystem 1106 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1102) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1106 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1100 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including proximity messages and data from which the proximity message is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine a dwell spot using distance measurements that track a user through their daily routine. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1-9. (canceled)

10. A method comprising performing, by a computing device:
accessing service data associated with a service and associated with a group of geographical regions;
for each of a set of map tiles:
assigning at least some of the service data of the group of geographical regions corresponding to the map tile; and
generating an initial batch of service data corresponding to the map tile, thereby generating initial batches of service data;
receiving, from a mobile device, a request to download map data corresponding a geographical area;
determining one or more map tiles corresponding to the geographical area;
determining a subset of the initial batches associated with the one or more map tiles corresponding to the geographical area; and
providing, to the mobile device, the subset of the initial batches responsive to the request.

11. The method of claim 10, further comprising:
determining that two or more of the initial batches comprise a set of shared data;
generating a synthetic batch comprising the set of shared data associated with the two or more of the initial batches;
removing the set of shared data from the two or more of the initial batches;
determining that the synthetic batch corresponds to the geographical area of the request; and
providing the synthetic batch to the mobile device responsive to the request.

12. The method of claim 11, wherein the set of shared data comprises data associated with a particular zoom level.

13. The method of claim 11, wherein the set of shared data comprises data shared between two or more adjacent map tiles.

14. The method of claim 11, wherein the synthetic batch comprises metadata that associates the set of shared data with each of the two or more initial batches.

15. The method of claim 10, wherein the geographical area is determined by a user input.

16. The method of claim 10, wherein the service data is organized according to the set of map tiles prior to assigning the at least some of the service data to the set of map tiles.

17. The method of claim 10, wherein determining the subset of the initial batches further comprises:
determining an expected wireless network coverage level associated with each of the one or more map tiles associated with the geographic area;
generating a total expected wireless network coverage level by combining the expected wireless network coverage level of each map tile; and
determining that the total expected wireless network coverage level is below a threshold.

18. (canceled)

19. A non-transitory computer-readable medium storing instructions that, when executed by one or more processors, cause the one or more processors to perform operations comprising:
accessing service data associated with a service and associated with a group of geographical regions;
for each of a set of map tiles:
assigning at least some of the service data of the group of geographical regions corresponding to the map tile; and
generating an initial batch of service data corresponding to the map tile, thereby generating initial batches of service data;
receiving, from a mobile device, a request to download map data corresponding a geographical area;
determining one or more map tiles corresponding to the geographical area;
determining a subset of the initial batches associated with the one or more map tiles corresponding to the geographical area; and
providing, to the mobile device, the subset of the initial batches responsive to the request.

20. The non-transitory computer-readable medium of claim 19, the operations further comprising:
determining that two or more of the initial batches comprise a set of shared data;
generating a synthetic batch comprising the set of shared data associated with the two or more of the initial batches;
removing the set of shared data from the two or more of the initial batches;
determining that the synthetic batch corresponds to the geographical area of the request; and
providing the synthetic batch to the mobile device responsive to the request.

21. The non-transitory computer-readable medium of claim 20, wherein the set of shared data comprises data associated with a particular zoom level.

22. The non-transitory computer-readable medium of claim 20, wherein the set of shared data comprises data shared between two or more adjacent map tiles.

23. The non-transitory computer-readable medium of claim 20, wherein the synthetic batch comprises metadata that associates the set of shared data with each of the two or more initial batches.

24. The non-transitory computer-readable medium of claim 19, wherein the geographical area is determined by a user input.

25. The non-transitory computer-readable medium of claim 19, wherein the service data is organized according to the set of map tiles prior to assigning the at least some of the service data to the set of map tiles.

26. A system, comprising:
one or more processors; and
a computer-readable memory comprising instructions that, when executed by the one or more processors, cause the system to perform operations to: access service data associated with a service and associated with a group of geographical regions;
for each of a set of map tiles:
assign at least some of the service data of the group of geographical regions corresponding to the map tile; and
generate an initial batch of service data corresponding to the map tile, thereby generating initial batches of service data;
receive, from a mobile device, a request to download map data corresponding a geographical area;
determine one or more map tiles corresponding to the geographical area;
determine a subset of the initial batches associated with the one or more map tiles corresponding to the geographical area; and
provide, to the mobile device, the subset of the initial batches responsive to the request.

27. The system of claim 26, wherein the instructions further cause the system to:
determine that two or more of the initial batches comprise a set of shared data;
generate a synthetic batch comprising the set of shared data associated with the two or more of the initial batches;
remove the set of shared data from the two or more of the initial batches;
determine that the synthetic batch corresponds to the geographical area of the request; and
provide the synthetic batch to the mobile device responsive to the request.

28. The system of claim 27, wherein the set of shared data comprises data associated with a particular zoom level.

29. The system of claim 27, wherein the set of shared data comprises data shared between two or more adjacent map tiles.

30. The system of claim 26, wherein the service data is organized according to the set of map tiles prior to assigning the at least some of the service data to the set of map tiles.
